(19) United States
(12) Patent Application Publication
(10) Pub. No.: US 2006/0292063 A1
(43) Pub. Date: Dec. 28, 2006

(54) Halide-containing ceramic

(76) Inventors: Martha O. Neustadt, Hillsboro, OR (US); Jacquelyn Pawela-Crew, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/168,054

(22) Filed: Jun. 27, 2005

(51) Int. Cl. C04B 35/00; C01F 7/02

(52) U.S. Cl. 423/625; 501/153; 501/127

(57) ABSTRACT

Embodiments of the present invention relate to the production of halide-containing ceramics. The halide-containing ceramics are formed by filling interstitial sites within the ceramic lattice structure with halide ions that can bind with the ceramic and eliminate the need to season the ceramic prior to using the ceramic in a reactive environment.

### BACKGROUND OF THE INVENTION

1. Field of the Invention

An embodiment of the present invention relates to ceramics and methods of fabricating ceramics. In particular, embodiments of the present invention relate to incorporating halides, such as fluorine, into ceramic lattice structures.

2. State of the Art

Ceramics are generally defined as any of a variety of inorganic, nonmetallic materials. They are typically crystalline in nature and are compounds formed between metallic and nonmetallic elements, such as aluminum and oxygen (alumina—Al₂O₃), calcium and oxygen (calcia—CaO), and silicon and nitrogen (silicon nitride—Si₃N₄).

Ceramics are used a variety of industrial and consumer applications. One ceramic in particular, alumina, is a very hard crystalline material which is stable, lightweight, and wear resistant. As such, alumina is very attractive for many applications including abrasives, insulators, structural members, refractory bricks, electronic substrates, tools, seal rings, air bearings, electrical insulators, valves, thread guides, and the like, depending on purity and density. It has a structure that may be described as a hexagonal closely-pack array of oxygen atoms with aluminum atoms in two-thirds of the octahedrally coordinated interstices. In other words, each aluminum atom is coordinated by six oxygen atoms, each of which has four aluminum neighbors (6:4 coordination). Such a structure is illustrated as lattice 300 in FIG. 7, wherein aluminum atoms are labeled as 302 and oxygen atoms are labeled as 304 with lines 306 representing atomic bonds between the aluminum atoms 302 and the oxygen atoms 304, and between certain oxygen atoms 304. The dashed lines 308 are not a part of the physical structure of the ceramic lattice. Rather, they are present to assist in discerning the three dimensional aspect of the lattice 300.

Alumina power may be produced on an industrial scale using the Bayer Process to separate ferric oxide, silica and aluminum oxides from bauxite ore, as will be understood by those skilled in the art. During the process, the alumina may be sprayed to form a fine powder. The processing of alumina is normally done in a non-reactive environment so that the ceramic remains as pure as possible—often greater than 99% pure Al₂O₃. Once the alumina powder is formed, it may be treated by milling or mixing. The alumina powder may then be formed into a green shape. Forming a green shape essentially comprises forming the alumina powder into a desired shape (called a “green body”), which may include, but not limited to cold pressing, injection molding, and slip casting including mixing the alumina powder with a binder, such as organic material(s). The green body may then be heated, such as baked in a kiln, where diffusion processes cause the green body to shrink, and close up the pores therein, resulting in a denser, stronger product. Generally, the firing is done at a temperature below the melting point of the ceramic.

In order to produce useful products, the alumina green body must be densified or sintered. Sintering is the process in which a crystalline ceramic powder is heat treated to form a single coherent solid. The driving force for sintering is the reduction in the free surface energy of the system. Sintering may be accomplished by a combination of two processes, the conversion of small particles into fewer larger ones (particle and grain growth) and coarsening, or the replacement of the gas/solid interface by a lower energy solid/solid interface (densification), as will be understood to those skilled in the art.

Ceramics components are used in numerous industries, including microelectronic manufacturing. In microelectronic manufacturing, high density plasma (HDP) equipment deposits thin film oxide, and nitride onto microelectronic wafers. In doing so, a combination of highly corrosive gasses, including chemicals such as NF₃ (nitrogen fluoride), are used to clean the the HDP chamber parts in situ. These corrosive gases are delivered into the chamber exposing the chamber walls and components to these gases. Many components of the HDP equipment (such as nozzles, baffles, walls, and the like) may be made of ceramic material to protect these components form the corrosive gases. However, these ceramic components must first be seasoned (i.e., exposed to the corrosive gases to incorporate the reactive elements in the ceramic) before they are put into production. Seasoning is necessary to prevent the ceramic parts from creating particles due to secondary crystallization on exposed surfaces of the ceramic parts. For example, if unseasoned alumina baffles were used in an HDP process with NF₃ gas, aluminum fluorine crystals would grow on the alumina baffles from the reaction of the alumina and the NF₃ gas. These aluminum fluorine crystals would then fall off the baffles and become contaminate particles on the microelectronic wafers, which are then subject to yield loss or scrapping depending on the severity of the particles.

Although, the seasoning process is necessary, it consumes many test wafers and costs equipment availability time. Thus, as time to market requirements increase, the need for faster throughput time at the HDP process demands the use of ceramics which can forgo the seasoning process.

### BRIEF DESCRIPTION OF THE DRAWINGS

While the specification concludes with claims particularly pointing out and distinctly claiming that which is regarded as the present invention, the advantages of this invention can be more readily ascertained from the following description of the invention when read in conjunction with the accompanying drawings in which:

FIG. 1 illustrates a flow diagram of one embodiment of a method to fabricate a halide-containing ceramic, according to the present invention;

FIG. 2 illustrates an oblique schematic view of a halide-containing ceramic, according to the present invention;

FIG. 3 illustrates an oblique schematic view of a halide-containing ceramic along line 3-3 of FIG. 2, according to the present invention;

FIG. 4 illustrates a flow diagram of another embodiment of a method to fabricate a halide-containing ceramic, according to the present invention;

FIG. 5 illustrates a flow diagram of still another embodiment of a method to fabricate a halide-containing ceramic, according to the present invention;

FIG. 6 illustrates a flow diagram of yet another embodiment of a method to fabricate a halide-containing ceramic, according to the present invention;

FIG. 7 illustrates a flow diagram of yet still another embodiment of a method to fabricate a halide-containing ceramic, according to the present invention; and

FIG. 8 illustrates an oblique schematic view of an alumina ceramic, as known in the art.

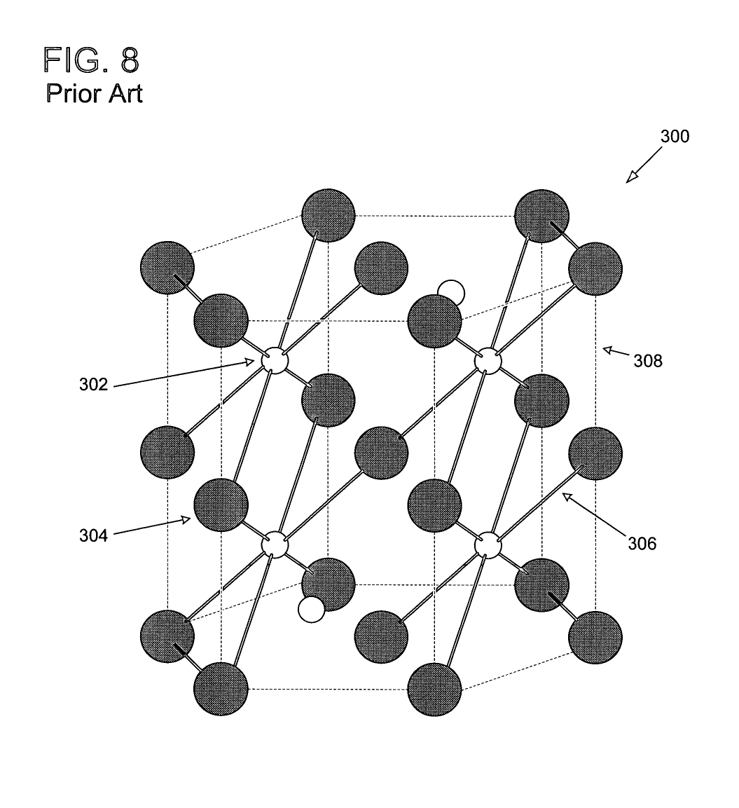

### DETAILED DESCRIPTION OF THE ILLUSTRATED EMBODIMENT

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein, in connection with one embodiment, may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Embodiments of the present invention relate to the production of halide-containing ceramics. The halide-containing ceramics are formed by filling interstitial sites within the ceramic lattice structure with halide ions than can bind with the ceramic and eliminate the need to season the products formed from the ceramic. Halides are, of course, understood to include fluorine, chlorine, bromine, iodine, and astatine. Hereinafter, a halide atom will be represented by the symbol “Ha”.

As previously discussed, ceramic parts used in high density plasma (HDP) thin film processes require a seasoning process to keep these parts from developing particles which can contaminate microelectronic wafer. Without the seasoning of alumina ceramic components, aluminum fluoride (AlₓF_{y}) particles, resulting from the reaction of the alumina ceramic and NF₃ (nitrogen fluoride) plasma (which is required in the HDP plasma process), can form on the exterior surface of alumina ceramic components. These particles can then dislodge from the alumina ceramic surface and contaminate or destroy a microelectronic wafer. Although seasoning is necessary, it is an expensive process which often takes up to 1000 test wafers and several days of tool time.

The need for seasoning may be significantly reduced or substantially eliminated by incorporating halide atoms, particularly fluorine, within the alumina crystal lattice itself, resulting in a “fluorine reaction resistant” ceramic. The incorporation of halide atoms into the alumina crystal lattice results in a halide-containing alumina ceramic which can no longer readily combine or react with fluorine from the NF₃ plasma, and, thus, the formation of surface crystals of aluminum fluoride will be significantly reduced or substantially eliminated. As such, seasoning becomes unnecessary.

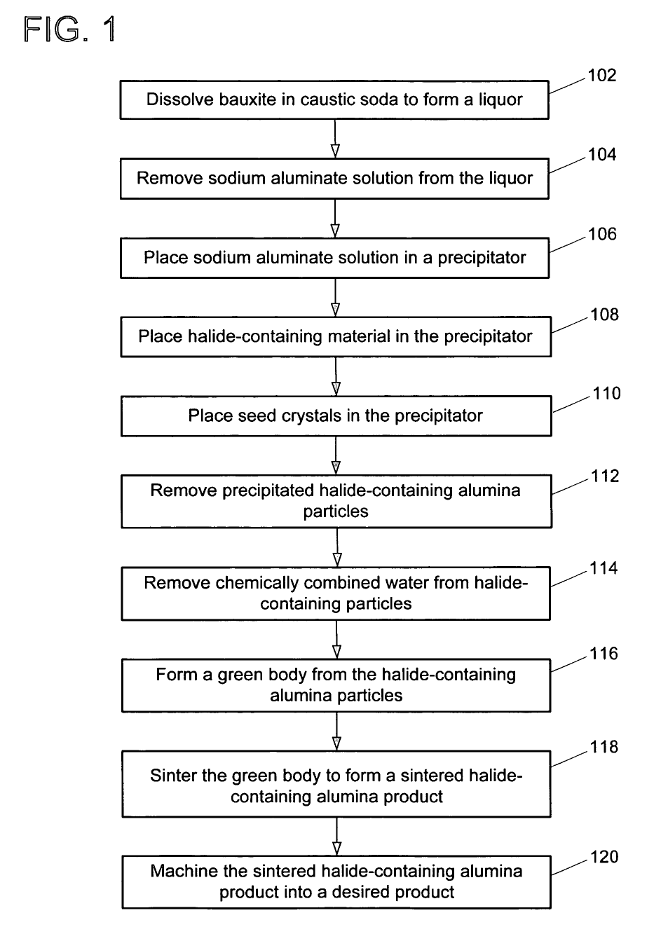

One embodiment of the present invention, as shown in FIG. 1, involves conducting the separation of ferric oxide, silica and aluminum oxides from bauxite ore in a halide rich environment. This means, essentially, that the Bayer Process is conducted with fluorine present. For example, bauxite is washed, ground, and dissolved in caustic soda at high pressure and temperature to form a liquor (step 102). The resulting liquor contains a solution of sodium aluminate and undissolved bauxite residues containing iron, silicon, and titanium. These residues sink and the sodium aluminate solution is extracted therefrom (step 104) and placed in a precipitator (step 106). Within the precipitator, a halide-containing material, such as hydrofluoric acid is added (step 108). Fine particles of alumina may be used as seed crystal, which are added to initiate the precipitation of alumina particles (step 110). However, as a halide is present in precipitator, the halide is incorporating into the alumina particles to form halide-containing alumina particles. The halide-containing alumina particles sink to the bottom of the precipitator where they are removed (step 112).

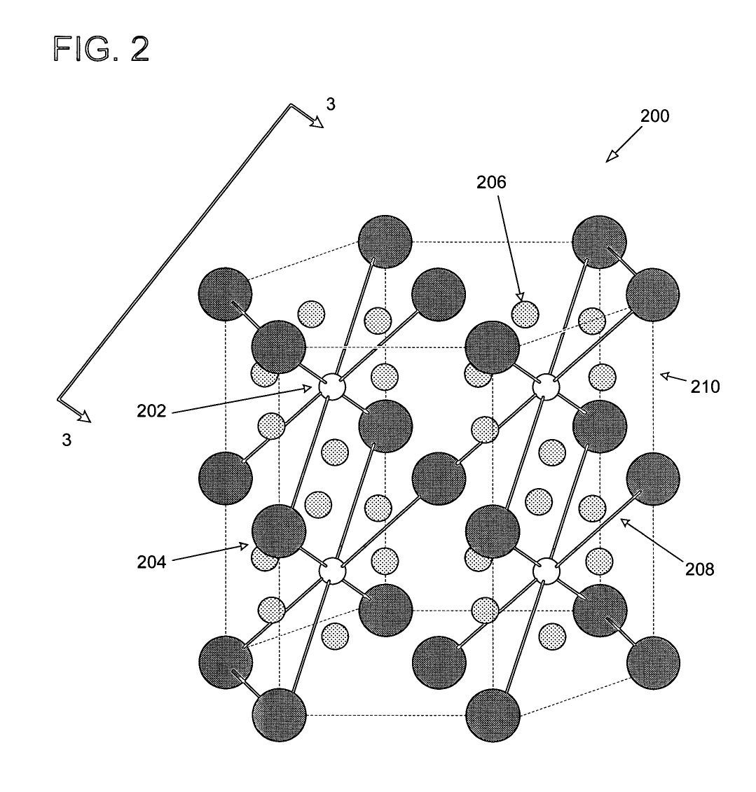

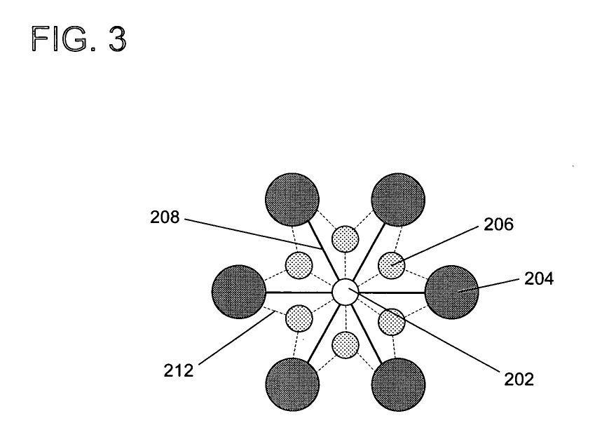

The crystals thus formed will constitute a new crystal lattice of some composition of aluminum, oxygen, and halide (AlₓO_{y}Ha_{z}). Although the new crystal lattice may have various structures, it is believed that the predominant structure will be Al₄O₆Ha₆, as shown as lattice 200 in FIG. 2, wherein each aluminum atom is coordinated by six oxygen atoms, each of which has four aluminum neighbors (6:4 coordination) that may be described as a hexagonal closely-pack array of oxygen atoms with aluminum atoms in two-thirds of the octahedrally coordinated interstices with the halide atom within the intersticial gaps. As illustrated in lattice 200 in FIG. 2, the aluminum atoms are labeled as 202, oxygen atoms are labeled as 204, and halide atoms are labeled as 206 with lines 208 representing atomic bonds between the aluminum atoms 202 and the oxygen atoms 204, and between certain oxygen atoms 204. In a preferred embodiment, the halide is fluorine, where the predominant structure will be Al₄O₆F₆. The dashed lines 210 are not a part of the physical structure of the ceramics. Rather, they are present to assist in discerning the three dimensional aspect of the lattice 200. FIG. 3 illustrates another view of the lattice 200 of FIG. 2, wherein the halide atoms 206 are in a substantially uniform distribution in the lattice's interstices areas, as will be understood to those skilled in the art. Dash lines 212 represent potential bonds which could be made between the halide atoms 208 and the aluminum atoms 202/oxygen atoms 204. It is, of course, understood that the lattice 200 may not be precisely uniform and may have less than 6 halides per sequence (i.e., Al₄O₆F₅, Al₄O₆F₄, etc.). Thus, FIGS. 2 and 3 are not meant to be precisely representative.

After removal of the halide-containing alumina particles, they may be passed through a rotary, fluidized calciner or sprayed into a chamber about 1100 degrees Celsius to drive off any chemically combined water (step 114). After which, a green body may formed (step 116), which is then sintered, preferably at temperatures above about 1600 degrees Celsius, to achieve a high density product (step 118). The resulting sintered halide-containing alumina products will have all the properties of an alumina ceramic, i.e., hard, tough, substantially inert, and will also be resistant to chemical reaction with NF₃ plasma in an HDP process. After sintering, the resulting sintered product may be machined into a desired product (step 120).

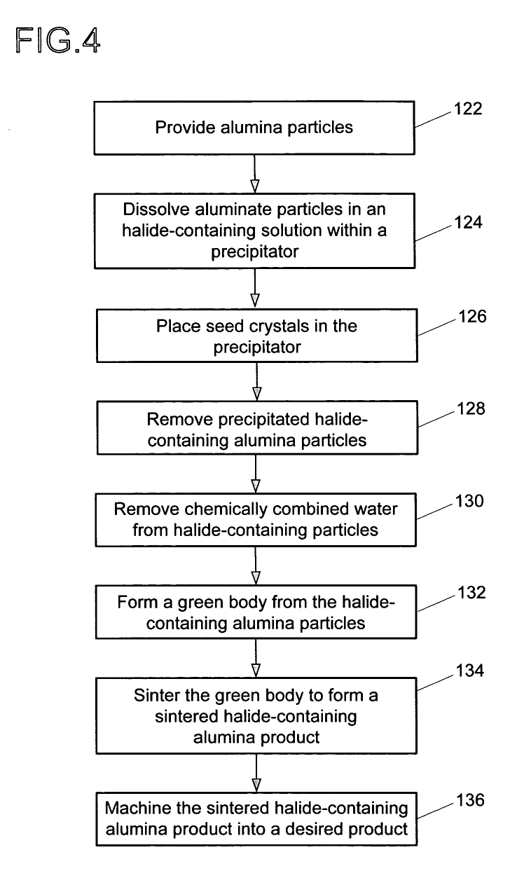

As shown in FIG. 4, it is, of course, understood that a similar result may be achieve by providing alumina particles (step 122) and dissolving the alumina particles in a halide-containing solution within a precipitator (step 124). Fine particles of alumina may be used as seed crystal, which are added to initiate the precipitation of alumina particles (step 126). However, as a halide is present in precipitator, the halide is incorporating into the alumina particles to form halide-containing alumina particles. The halide-containing alumina particles sink to the bottom of the precipitator where they are removed (step 128). As previously discussed, any chemically combined water may be removed from the halide-containing particles (step 130). Again, after the formation of the halide-containing alumina particles, a green body may formed (step 132), which is then the sintered at temperatures above about 1600° C. to achieve a high density product (step 134). The resulting sintered halide-containing alumina product will have all the properties of an alumina ceramic, i.e., hard, tough, substantially inert, and will also be resistant to chemical reaction with NF₃ in HDP process. After sintering, the resulting sintered product may be machined into a desired product (step 136).

In its most fundamental aspects, the methods of FIGS. 1 and 4 can be described as forming a solution for ceramics particles and a halide-containing material, precipitating halide-containing ceramic particles from the solution, forming a green body from the halide-containing ceramic particles, and sintering the halide-containing ceramic green body.

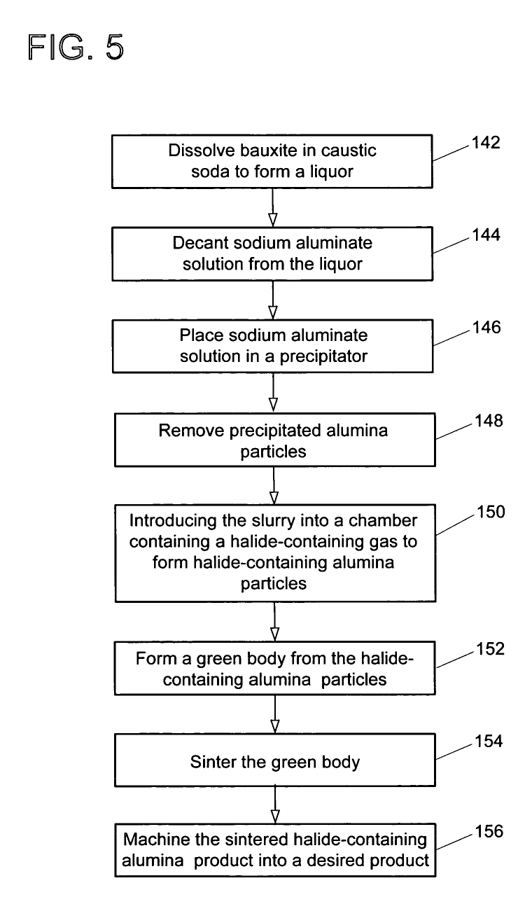

Another embodiment of the present invention, as shown in FIG. 5, involves conducting a normal separation of ferric oxide, silica and aluminum oxides from bauxite ore in with the Bayer Process. Again, as previously described, the bauxite is washed, ground, and dissolved in caustic soda at high pressure and temperature to form a liquor (step 142). The resulting liquor contains a solution of sodium aluminate and undissolved bauxite residuals containing iron, silicon, and titanium. These residues sink and the sodium aluminate solution is extracted off (step 144) and placed in a precipator (step 146), wherein the alumina is precipitated and removed (step 148).

After removal of the alumina particles, they are be introduced to a chamber containing a halide-containing gas (step 150), preferably at a temperature of about 1100 degrees Celsius, such as being passed through a rotary, fluidized calciner in a halide-containing gas or sprayed into a chamber containing a halide-containing gas. This may simultaneously result in the reaction of the alumina and the halide in the halide-containing gas and drive off any chemically combined water. The halide-containing gas may include but is not limited to, hydrogen fluoride gas (HF), tetrafluorosilane gas (SiF₄), fluorine gas (F₂) or any other appropriate halide compound-containing gas.

Again, the crystals thus formed will constitute a new crystal lattice of some composition of aluminum, oxygen, and halide (AlₓO_{y}Ha_{z}). Although the new crystal lattice may have various structures, it is believed that the predominant structure will be Al₄O₆Ha₆, as shown in FIGS. 2 and 3.

Again, after the formation of the halide-containing alumina particles, a green body may formed (step 152), which is then the sintered at temperatures above about 1600° C. to achieve a high density product (step 154). The resulting sintered halide-containing alumina product will have all the properties of an alumina ceramic, i.e., hard, tough, substantially inert, and will also be resistant to chemical reaction with NF₃ in HDP process. After sintering, the resulting sintered product may be machined into a desired product (step 156).

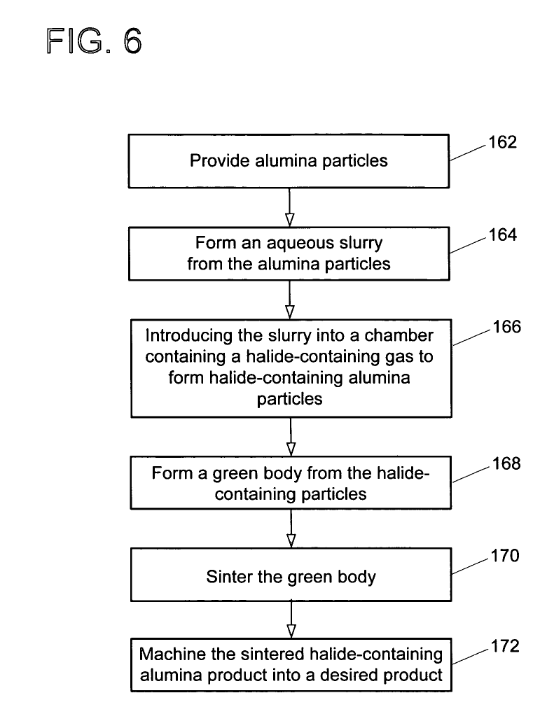

As shown in FIG. 6, it is, of course, understood that a similar result may be achieve by providing substantially pure alumina (step 162), forming an aqueous slurring (step 164), and spraying the slurry into a chamber containing a halide-containing gas (step 166), as described above, to form halide-containing alumina particles. Again, after the formation of the halide-containing alumina particles, a green body may formed (step 168), which is then the sintered at temperatures above about 1600° C. to achieve a high density product (step 170). The resulting sintered halide-containing alumina product will have all the properties of an alumina ceramic, i.e., hard, tough, substantially inert, and will also be resistant to chemical reaction with NF₃ in HDP process. After sintering, the resulting sintered product may be machined into a desired product (step 172).

In its most fundamental aspects, the methods of FIGS. 5 and 6 can be described as providing an aqueous ceramic slurry, introducing the aqueous ceramic slurry into a chamber containing a halide-containing gas to form halide-containing particles, forming a green body from the halide-containing ceramic particles, and sintering the halide-containing ceramic green body.

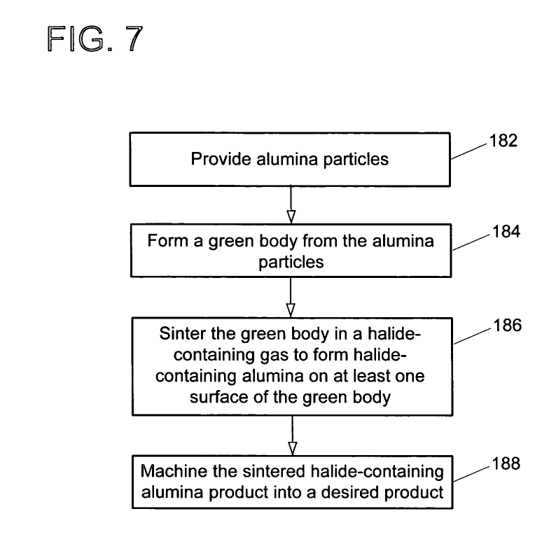

Still another embodiment of the present invention, as shown in FIG. 7, involves providing an alumina powder (step 182) and forming it into a green body (step 184). The green body is then sintered in a halide-containing gas (step 186), including but is not limited to, hydrogen fluoride gas (HF), tetrafluorosilane gas (SiF₄), fluorine gas (F₂) or any other appropriate halide compound-containing gas, which resulting in the formation of a new crystal lattice of some composition of aluminum, oxygen, and halide (AlₓO_{y}Ha_{z}) proximate the exterior surfaces of the resulting ceramic product. Again, although the new crystal lattice may have various structures, it is believed that the predominant structure will be Al₄O₆Ha₆, as shown in FIGS. 2 and 3.

Yet again, the sintered may be conducted at a temperature above about 1600° C. to achieve a high density product. The resulting sintered halide-containing alumina ceramic product will have all the properties of an alumina ceramic, i.e., hard, tough, substantially inert, and will also be resistant to chemical reaction with NF₃ in HDP process. After sintering, the resulting sintered product may be machined into a desired product (step 188). However, as machining may removed the halide-containing alumina ceramic from the surface of the halide-containing alumina ceramic product, in situations where machining is necessary, forming the halide-containing alumina ceramic prior to sintering may be advantageous.

The ability to eliminate the seasoning process, as described in the present invention, without impact to yield levels due to particle contaminates will provide fast time to market, lower costs, and lower throughput times.

It is, of course, understood that although the description of the present invention is primarily focused on alumina ceramics and fluorine, the teachings and principles of the present invention are not so limited and can be applied to a variety of ceramics and any halide.

Having thus described in detail embodiments of the present invention, it is understood that the invention defined by the appended claims is not to be limited by particular details set forth in the above description, as many apparent variations thereof are possible without departing from the spirit or scope thereof.

What is claimed is:

1. A method of fabricating a ceramic, comprising:
forming a solution from ceramic particles and a halide-containing material;
precipitating halide-containing ceramic particles from the solution;
forming a green body from the halide-containing ceramic particles; and
sintering the halide-containing ceramic green body.

2. The method of claim 1, wherein forming the solution from ceramic particles and the halide-containing material comprises forming a solution from alumina particles and the halide-containing material.

3. The method of claim 2, wherein forming the solution from alumina particles and the halide-containing material comprises:
dissolving bauxite in caustic soda to form a liquor;
removing a sodium aluminate solution from the liquor;
placing the sodium aluminate solution in a precipitator; and
placing a halide-containing material in the precipitator.

4. The method of claim 1, wherein forming the solution from ceramic particles and the halide-containing material comprises forming a solution from ceramic particles and a fluorine-containing material.

5. The method of claim 4, wherein forming the solution from ceramic particles and the fluorine-containing material comprises forming a solution from ceramic particles and a fluorine-containing material selected from the materials comprising hydrofluoric acid.

6. The method of claim 1, further including removing chemically combined water from the halide-containing ceramic particle prior to the formation of the green body.

7. The method of claim 1, wherein forming the solution from ceramic particles and the halide-containing material comprises providing ceramic particles and dissolving the ceramic particles in a halide-containing solution.

8. The method of claim 1, wherein precipitating halide-containing ceramic particles from the solution includes introducing a seed material to the solution.

9. A method of fabricating a ceramic, comprising:
providing an aqueous ceramic slurry;
introducing the aqueous ceramic slurry into a chamber containing a halide-containing gas to
form halide-containing ceramic particles;
forming a green body from the halide-containing ceramic particles; and
sintering the halide-containing ceramic green body.

10. The method of claim 9, wherein forming the aqueous ceramic slurry comprises forming an aqueous alumina ceramic slurry.

11. The method of claim 10, wherein forming the aqueous alumina ceramic slurry comprises:
dissolving bauxite in caustic soda to form a liquor;
removing sodium aluminate solution from the liquor;
precipitating the aluminate particles from the aluminate solution; and
dissolving the aluminate particles.

12. The method of claim 9, wherein introducing the aqueous ceramic slurry into a chamber containing a halide-containing gas comprises introducing the aqueous ceramic slurry into a chamber containing a halide-containing gas selected from the materials comprising hydrogen fluoride gas, tetrafluorosilane gas, and fluorine gas.

13. The method of claim 9, wherein providing an aqueous ceramic slurry comprises dissolving alumina particles in water.

14. The method of claim 9, wherein introducing the aqueous ceramic slurry into the chamber containing a halide-containing gas comprises spraying the aqueous ceramic slurry into a chamber containing a fluorine-containing gas.

15. The method of claim 9, wherein introducing the aqueous ceramic slurry into the chamber containing a halide-containing gas comprises passing the aqueous ceramic slurry through a rotary, fluidized calciner in a halide-containing gas.

16. A method of fabricating a ceramic, comprising:
providing ceramic particles;
forming a green body from the ceramic particles; and
sintering the ceramic green body in the presence of a halide-containing gas.

17. The method of claim 16, wherein providing ceramic particles comprises providing alumina ceramic particles.

18. The method of claim 17, wherein providing the alumina ceramic particles comprises:
dissolving bauxite in caustic soda to form a liquor;
removing sodium aluminate solution from the liquor; and
precipitating the aluminate particles from the aluminate solution.

19. The method of claim 16, wherein sintering the ceramic green body in the presence of a halide-containing gas comprises sintering the ceramic green body in the presence of a halide-containing gas selected from the materials comprising hydrogen fluoride gas, tetrafluorosilane gas, and fluorine gas.
